(19) United States
(12) Patent Application Publication
(10) Pub. No.: US 2022/0258338 A1
(43) Pub. Date: Aug. 18, 2022

(54) DATA GENERATION APPARATUS AND DATA GENERATION SYSTEM

(71) Applicant: SONY GROUP CORPORATION, TOKYO (JP)

(72) Inventor: TAKARA KASAI, TOKYO (JP)

(21) Appl. No.: 17/629,326

(22) PCT Filed: Jul. 20, 2020
(86) PCT No.: PCT/JP2020/028149

§ 371 Date: Jan. 21, 2022

(30) Foreign Application Priority Data
Aug. 2, 2019 (JP) 2019-142968

(51) Int. Cl. B25J 9/16; G06F 16/901; B25J 9/10

(52) U.S. Cl. CPC B25J 9/1653; B25J 9/1065; G06F 16/9024

(57) ABSTRACT

A data generation apparatus according to one embodiment of the present disclosure includes: a first graph generator that generates a first graph representing a structure of a link mechanism; and a second graph generator that generates a second graph representing an interlocking relationship between a driving joint and a driven joint, the driving joint and the driven joint being included in the link mechanism, the driven joint being driven in a manner that the driven joint interlocks with the driving joint.

### TECHNICAL FIELD

The present disclosure relates to a data generation apparatus and a data generation system.

### BACKGROUND ART

With the widespread of robotic devices, various techniques have recently been developed for methods of controlling the robotic devices (e.g., PTL 1).

For example, there has been proposed a distributed processing control system that controls output of an actuator while constantly acquiring information from a sensor by a processor distributed in each of the sensor and the actuator mounted on a robot device.

In the distributed processing system, the distributed processors are able to perform concurrent control. Thus, the distributed processing system is able to control each part of a robotic device more quickly as compared with a central processing system that performs centralized control by a main processor.

### CITATION LIST

### Patent Literature

PTL 1: Japanese Unexamined Patent Application Publication No. 2012-157964

### SUMMARY OF THE INVENTION

It is important in such a distributed processing system to share data among distributed processors in order to perform an integrated operation on the robotic device as a whole. Accordingly, it is desirable to handle data related to a body model of the robotic device in a format that is easier to share.

A data generation apparatus according to one embodiment of the present disclosure includes: a first graph generator that generates a first graph representing a structure of a link mechanism; and a second graph generator that generates a second graph representing an interlocking relationship between a driving joint and a driven joint, the driving joint and the driven joint being included in the link mechanism, the driven joint being driven in a manner that the driven joint interlocks with the driving joint.

A data generation system according to one embodiment of the present disclosure includes: a first graph generator that generates a first graph representing a structure of a link mechanism; and a second graph generator that generates a second graph representing an interlocking relationship between a driving joint and a driven joint, the driving joint and the driven joint being included in the link mechanism, the driven joint being driven in a manner that the driven joint interlocks with the driving joint.

In the data generation apparatus and the data generation system according to the embodiments of the present disclosure, it is possible to express the closed-link structure included in the link mechanism by a combination of a plurality of acyclic graphs. This allows for generation of data expressing the link mechanism including the closed-link structure, without using a cyclic graph which is incompatible with many components and software bases, for example.

### BRIEF DESCRIPTION OF DRAWINGS

FIG. 1 is an explanatory diagram illustrating data sharing in a distributed processing system.

FIG. 2 is an explanatory diagram illustrating sharing of a body model between software bases in a robotic device.

FIG. 3 is a block diagram illustrating a functional configuration of a data generation apparatus according to one embodiment of the present disclosure.

FIG. 4 is a flowchart illustrating an example of an operation of a data generation apparatus 10 according to one embodiment of the present disclosure.

FIG. 5 is a schematic view of a structure of a link mechanism according to a first specific example.

FIG. 6A is a graph diagram illustrating an example of a first graph generated by the data generation apparatus 10 on the basis of the link mechanism according to the first specific example.

FIG. 6B is a graph diagram illustrating an example of a second graph generated by the data generation apparatus 10 on the basis of the link mechanism according to the first specific example.

FIG. 7 is a schematic view of a structure of a link mechanism according to a second specific example.

FIG. 8A is a graph diagram illustrating an example of a first graph generated by the data generation apparatus 10 on the basis of the link mechanism according to the second specific example.

FIG. 8B is a graph diagram illustrating an example of a second graph generated by the data generation apparatus 10 on the basis of the link mechanism according to the second specific example.

FIG. 9 is a schematic view of a structure of a link mechanism according to a third specific example.

FIG. 10 is a graph diagram illustrating an example of a first graph generated by the data generation apparatus 10 on the basis of the link mechanism according to the third specific example.

FIG. 11A is a graph diagram illustrating an example of a second graph generated by the data generation apparatus 10 on the basis of the link mechanism according to the third specific example.

FIG. 11B is a graph diagram illustrating an example of the second graph generated by the data generation apparatus 10 on the basis of the link mechanism according to the third specific example.

FIG. 12 is a schematic view of a structure of a link mechanism according to a fourth specific example.

FIG. 13 is a graph diagram illustrating an example of a first graph generated by the data generation apparatus 10 on the basis of the link mechanism according to the fourth specific example.

FIG. 14A is a graph diagram illustrating an example of a second graph generated by the data generation apparatus 10 on the basis of the link mechanism according to the fourth specific example.

FIG. 14B is a graph diagram illustrating an example of the second graph generated by the data generation apparatus 10 on the basis of the link mechanism according to the fourth specific example.

FIG. 15 is a block diagram illustrating a hardware configuration example of the data generation apparatus 10 according to one embodiment of the present disclosure.

### MODES FOR CARRYING OUT THE INVENTION

The following describes embodiments of the present disclosure in detail with reference to the drawings. The following description is a specific example of the present disclosure, but the present disclosure is not limited to the following embodiments. In addition, the present disclosure is not limited to arrangement, dimensions, dimensional ratios, and the like of the constituent elements illustrated in the drawings.

It is to be noted that description is given in the following order.

### 1. Outline of Technology According to Present Disclosure

### 2. Configuration Example of Data Generation Apparatus

### 3. Operation Example of Data Generation Apparatus

### 4. Specific Examples

### 5. Hardware Configuration Example

### 6. Appendix

### 1. OUTLINE OF TECHNOLOGY ACCORDING TO PRESENT DISCLOSURE

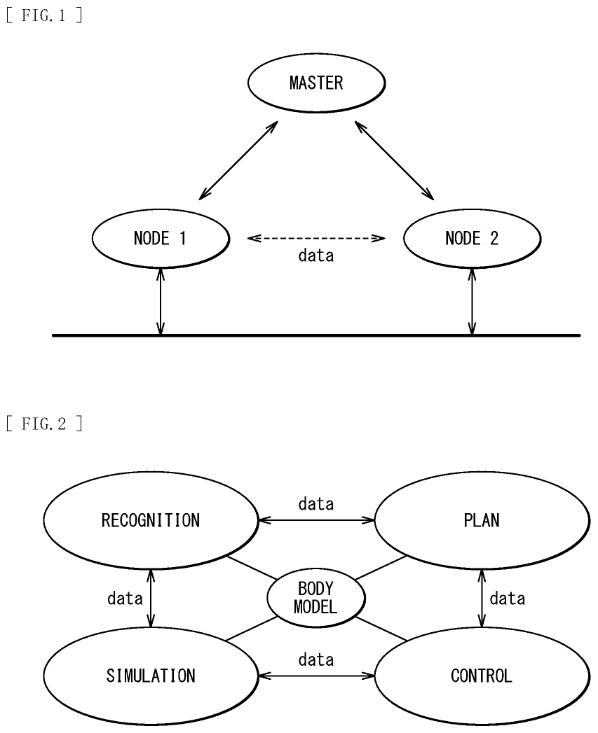

First, referring to FIG. 1 and FIG. 2, an outline of a technology according to the present disclosure will be described. FIG. 1 is an explanatory diagram illustrating data sharing in a distributed processing system. FIG. 2 is an explanatory diagram illustrating sharing of a body model between software bases in a robotic device.

As used herein, the robotic device refers to a mechanical device that is able to imitate a motion of a living thing by electro-magnetic or mechanical power. For example, the robotic device may include a manipulator of a pet robot, a two- or four-legged walking robot, a robot arm, or the like. The robotic device may also include an articulated device or an autonomous control device that autonomously perform sequential or random automatic tasks.

In such a robotic device, in order to control an operation of each part, many sensors and actuators are distributed in each part. Control devices of actuators are also distributed in the vicinity of the actuators or the sensors to control the actuators more quickly on the basis of data sensed by the sensors. The distributed control devices control the operation of the robotic device as a whole by transmitting and receiving operation requests, control requests, sensing data, a body model of the robotic device, or the like to and from each other.

For example, as illustrated in FIG. 1, in a case where independent control is performed at a plurality of distributed nodes (a node 1 and a node 2), the plurality of nodes (the node 1 and the node 2) performs control on the robotic device as a whole by transmitting and receiving data between the nodes using a communication channel called a topic. Specifically, the plurality of nodes (the node 1 and the node 2) is managed by a master, and the plurality of nodes (the node 1 and the node 2) performs the control by transmitting and receiving data identified by the master to and from each other.

The distributed processing system to be used for controlling the robotic device shares data between a set of functions such as nodes (i.e., components) and causes the components to cooperate with each other, to thereby perform a series of controls in the robotic device. For this reason, it is desirable that each component be able to easily share data by transmitting and receiving data in a common format.

Further, there are various kinds of software bases (i.e., platforms) related to the robotic device for each application.

For example, as illustrated in FIG. 2, examples of the software bases related to the robotic device may include: a platform related to recognition of an object by a sensor; a platform related to creation of an operation plan of the robotic device; a platform related to control on an actuator of the robotic device; and a platform related to simulation on motion of the robotic device.

These software bases handle a body model of the robotic device in common. Accordingly, as with the nodes, it may be possible to perform calculation more efficiently by sharing the body model of the robotic device between the software bases. In particular, in a case where the plurality of software bases handles the same robotic device, sharing the body model of the robotic device between the plurality of software bases may allow data or a calculation result related to the robotic device to be shown to each other.

However, the different software bases may have respective available data formats of the body model that are different from each other. Accordingly, it is desirable to provide technology that makes it possible to cause the data related to the body model of the robotic device to be mutually handleable even among the different software bases.

The technology according to the present disclosure has been implemented in consideration of the above circumstances. The technology according to the present disclosure makes it possible to share the data related to the body model of the robotic device among the plurality of components or software bases by representing the body model of the robotic device by a combination of plain expressions.

For example, one embodiment of the present disclosure provides a data generation apparatus that generates data in which a body model of a robotic device is expressed by a plurality of acyclic graphs. According to the data generation apparatus of one embodiment of the present disclosure, it is possible to generate data related to the body model that makes it possible to be shared smoothly among a plurality of components or software bases.

### 2. CONFIGURATION EXAMPLE OF DATA GENERATION APPARATUS

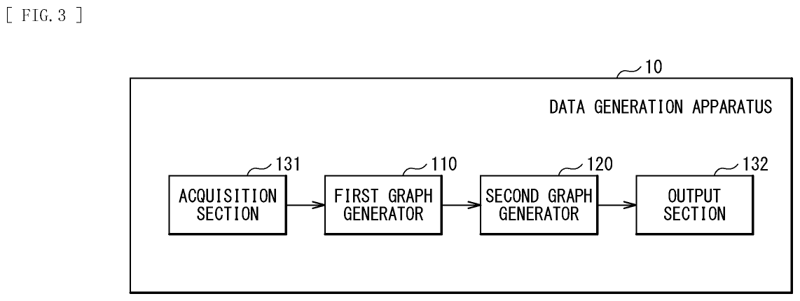

Next, referring to FIG. 3, a configuration of a data generation apparatus according to one embodiment of the present disclosure will be described. FIG. 3 is a block diagram illustrating a functional configuration of the data generation apparatus according to the present embodiment.

As illustrated in FIG. 3, a data generation apparatus 10 according to the present embodiment includes, for example, an acquisition section 131, a first graph generator 110, a second graph generator 120, and an output section 132.

The acquisition section 131 acquires data necessary for generating data representing a body model of a robotic device. Specifically, the acquisition section 131 may acquire information related to a link mechanism included in the robotic device. For example, the acquisition section 131 may acquire information related to: a linkage between links and joints in a link mechanism including legs or arms of the robotic device; a length of each link; a movable range of each joint; and the presence or absence of an actuator in each joint.

The acquisition section 131 may acquire the information related to the link mechanism on the basis of sensing data from a sensor or an imaging device included in the robotic device. Alternatively, the acquisition section 131 may acquire the information related to the link mechanism on the basis of specification information stored in a storage unit included in the robotic device.

The first graph generator 110 generates a first graph representing an overall structure of the link mechanism. The first graph generated by the first graph generator 110 is an acyclic graph in which the links are each represented by a node (vertex) and the joints are each represented by an edge (branch), and is a graph representing a simplified structure of the link mechanism.

Specifically, the first graph generator 110 first generates a mechanism model in which a closed-link structure of the link mechanism is converted into an open-link structure by removing a dependent link from the closed-link structure included in the link mechanism. For example, the first graph generator 110 may convert the closed-link structure into the open-link structure by removing one of dependent links included in the closed-link structure. Here, the dependent link is a link that rotates in association with rotation of another link. In other words, the dependent link is a link to which a driving joint that is rotated by an actuator or the like is not joined, and to which a driven joint that is rotated in association with rotation of another driving joint is joined.

Thereafter, the first graph generator 110 generates the first graph representing the structure of the link mechanism on the basis of the mechanism model obtained by converting the closed-link structure of the link mechanism into the open-link structure. For example, the first graph generator 110 may generate, as the first graph, a graph in which the links of the generated mechanism model are each represented by a node (vertex) and the joints of the generated mechanism model are each represented by an edge (branch). In this case, the first graph generator 110 may generate the first graph by setting a link joined to the driving joint to a parent node (origin), and may also generate the first graph by setting a link closest to a body of the robotic device to the parent node (origin).

According to this, the first graph generator 110 is able to convert the closed-link structure into the open-link structure by removing the dependent link from the closed-link structure included in the link mechanism; therefore, it is possible to represent the structure of the link mechanism by the acyclic graph.

In a case where the closed-link structure included in the link mechanism is shown as a graph as it is, the closed-link structure is represented by a cyclic graph including a closed chain. However, the cyclic graph can be incompatible with some components or software bases because of the complexity of vertex relationships. The data generation apparatus 10 converts the closed-link structure included in the link mechanism into the open-link structure, and is thereby able to represent the structure of the link mechanism by the acyclic graph that does not include the closed chain. This makes it possible for the first graph generator 110 to generate data that is handleable by more components or software bases.

The second graph generator 120 generates a second graph representing an interlocking relationship between the driving joint and the driven joint included in the link mechanism for each interlocking relationship. The second graph generated by the second graph generator 120 is an acyclic graph in which the links are each represented by a node (vertex) and the joints are each represented by an edge (branch), and is a graph representing an interlocking relationship of the links or an interlocking relationship of the joints attributed to the closed-link structure of the link mechanism. The second graph generator 120 is able to represent the interlocking the relationship of the joints in a graph by setting a virtual link that joins the joints to be interlocked with each other.

Specifically, the second graph generator 120 first specifies a driving joint and a driven joint which are in an interlocking relationship in the mechanism model generated by the first graph generator 110, and sets a virtual link that joins the driving joint and the driven joint to each other. Thereafter, the second graph generator 120 generates the second graph in which: the set virtual link is represented by a parent node; the driving joint and the driven joint in the interlocking relationship are each represented by an edge; and links that are joined to respective joints of the driving joint and the driven joint are each represented by a child node. In this case, the links, which serve as the child nodes, to be joined to the respective joints of the driving joint and the driven joint are links that do not contribute to the joining between the driving joint and the driven joint in the mechanism model. In other words, the child node of the second link is a link that exists on an opposite side to the virtual link that is the parent node, with respect to the driving joint or the driven joint.

It is to be noted that, in a case where there is a link that directly joins to each other the driving joint and the driven joint which are in the interlocking relationship, the second graph generator 120 may use, as the above-described virtual link, the link that directly joins the driving joint and the driven joint to each other.

In addition, the second graph generator 120 may add supplementary information indicating the interlocking relationship between the driving joint and the driven joint to the second graph. Specifically, the second graph generator 120 may add, as the supplementary information to the second graph, information related to weighting of each of the edges that join the parent node and the child node to each other (the driving joint and the driven joint correspond to the respective edges). Further, in a case where the interlocking relationship between the driving joint and the driven joint is not linear, the second graph generator 120 may add a polynomial representing the interlocking relationship between the driving joint and the driven joint to the second graph as the supplementary information.

The output section 132 outputs information representing the body model of the robotic device to outside. Specifically, the output section 132 outputs information including the first graph and the second graph which express the link mechanism included in the robotic device to an external component or a software base. The first graph and the second graph outputted from the output section 132 each represent the structure and movement of the link mechanism in a simple acyclic graph. This makes it possible for other components or software bases to smoothly use the first graph and the second graph.

The data generation apparatus 10 according to the present embodiment uses: the first graph that simulatively represents the closed-link structure included in the link mechanism by the open-link structure; and the second graph that represents the interlocking relationship of the joints attributed to the closed-link structure. This makes it possible to represent the structure and the movement of the closed-link structure without using a cyclic graph.

It is to be noted that the structure of the link mechanism that may be represented by the data generation apparatus 10 according to the present embodiment is a closed-link structure that is not a underactuated system. The underactuated system is a system including a joint such as a free joint whose rotation angle is not uniquely determined. It is difficult to simulatively represent the closed-link structure of the underactuated system in the acyclic graph by the data generation apparatus 10. Thus, the closed-link structure of the underactuated system is not targeted by the technology according to the present disclosure.

### 3. OPERATION EXAMPLE OF DATA GENERATION APPARATUS

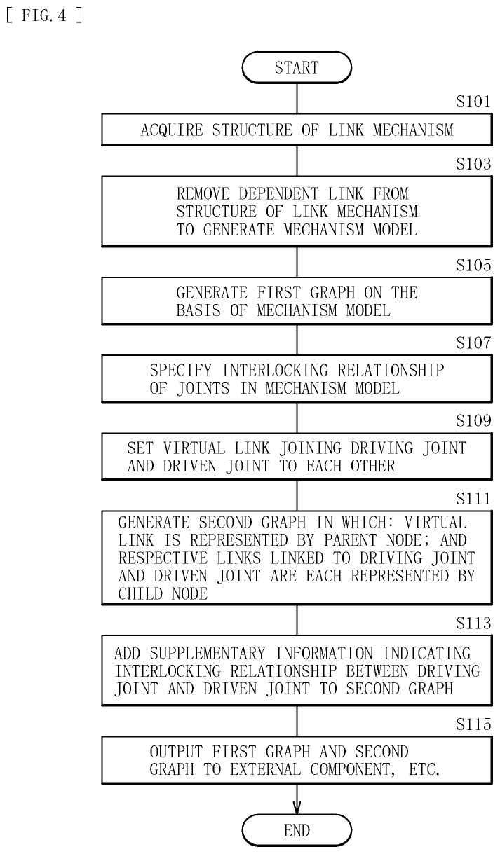

Next, referring to FIG. 4, an operation example of the data generation apparatus 10 according to the present embodiment will be described. FIG. 4 is a flowchart illustrating an example of an operation of the data generation apparatus 10 according to the present embodiment.

As illustrated in FIG. 4, first, the acquisition section 131 acquires the information related to the structure of the link mechanism included in the robotic device (S101). The acquisition section 131 may acquire the information related to the structure of the link mechanism on the basis of measurement information of the robotic device obtained by a sensor or the like, or may acquire the information related to the structure of the link mechanism on the basis of design information of the robotic device stored in advance.

Thereafter, the first graph generator 110 removes the dependent link from the structure of the link mechanism to generate the mechanism model (S103). Specifically, the first graph generator 110 removes one dependent link that is not joined to the driving joint from the closed-link structure included in the link mechanism, thereby generating the mechanism model in which the closed-link structure is converted into the open-link structure.

Thereafter, the first graph generator 110 generates the first graph on the basis of the generated mechanism model (S105). Specifically, the first graph generator 110 generates the first graph in which the links of the mechanism model are each represented by the node and the joints of the mechanism model are each represented by the edge.

Thereafter, the second graph generator 120 specifies the interlocking relationship of the joints in the mechanism model (S107). The interlocking relationship of the joints in the mechanism model may be formed by transmitting power from one actuator to a plurality of joints, or may be formed by the closed-link structure.

Here, the second graph generator 120 sets the virtual link joining to each other the driving joint and the driven joint which are in the interlocking relationship (S109). It is to be noted that in a case where the driving joint and the driven joint which are in the interlocking relationship are joined to each other via a real link, the second graph generator 120 may use the real link as the virtual link.

Thereafter, the second graph generator 120 generates the second graph in which: the virtual link is represented by the parent node; the driving joint and the driven joint linked to the virtual link are each represented by the edge; and the links linked to respective joints of the driving joint and the driven joint are each represented by the child node (S111).

Thereafter, the second graph generator 120 adds the supplementary information indicating the interlocking relationship between the driving joint and the driven joint to the second graph (S113). For example, the second graph generator 120 may add, to the second graph, the supplementary information that represents the interlocking relationship between the driving joint and the driven joint as the weighting for each edge of the second graph. Further, the second graph generator 120 may add to the second graph the supplementary information representing the interlocking relationship between the driving joint and the driven joint as a polynomial.

Thereafter, the output section 132 outputs the first graph and the second graph to an external component or the like (S115). The first graph and the second graph that have been outputted are each represented by the acyclic graph. This enables easy handling of the first graph and the second graph in various components and software bases without performing any specific measures.

### 4. SPECIFIC EXAMPLES

Next, referring to FIGS. 5 to 14B, specific examples of data generation performed by the data generation apparatus 10 according to the present embodiment will be described.

### First Specific Example

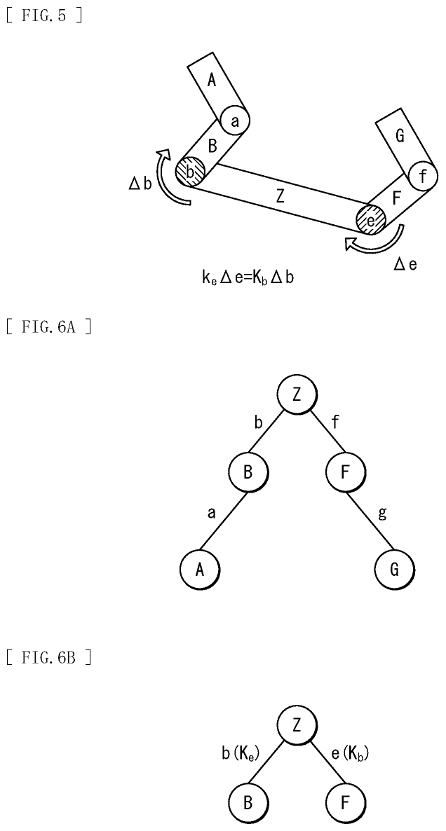

First, referring to FIGS. 5 to 6B, a first specific example will be described. FIG. 5 is a schematic view of a structure of a link mechanism according to the first specific example. FIG. 6A is a graph diagram illustrating an example of the first graph generated by the data generation apparatus 10 on the basis of the link mechanism according to the first specific example. FIG. 6B is a graph diagram illustrating an example of the second graph generated by the data generation apparatus 10 on the basis of the link mechanism according to the first specific example.

As illustrated in FIG. 5, the link mechanism according to the first specific example includes: a link A, a link B, a link Z, a link F, and a link G; and a joint a, a joint b, a joint e, and a joint f. Specifically, the joint b and the joint e are each linked to corresponding one of both ends of the link Z. The joint b joins the link Z and the link B to each other; and the joint a provided on the other end, which is opposite to the joint b, of the link B joins the link B and the link A to each other. Further, the joint e joins the link Z and the link F to each other; and the joint f provided on the other end, which is opposite to the joint e, of the link F joins the link F and the link G to each other.

In the link mechanism according to the first specific example, the joint e is the driving joint and the joint b is the driven joint that interlocks with the joint e. Specifically, there is the interlocking relationship between the joint e and the joint b that: when the joint e rotates by an angle Δe, the joint b rotates by an angle Δb. That is, using constants, the interlocking relationship between the joint e and the joint b is represented by Kₑ·Δe=K_{b}·Δb.

The graph in FIG. 6A represents the first graph generated for the link mechanism according to such a first specific example. Specifically, the first graph is a graph in which each of the links of the link mechanism related to the first specific example is represented by a node and each of the joints of the link mechanism related to the first specific example is represented by an edge. For example, the first graph may be a graph in which: the link B and the link F are joined to the link Z serving as the parent node via the joint b and the joint e, respectively; the link A is joined to the link B via the joint a; and the link G is joined to the link F via the joint f.

Further, the graph in FIG. 6B represents the second graph generated for the link mechanism according to the first specific example. Specifically, the second graph is a graph in which: the real link that joins the joints which are in the interlocking relationship is represented by the parent node; and the links rotated by the respective joints which are in the interlocking relationship are each represented by the child node. For example, the second graph may be a graph in which: the link Z that joins the joint b and the joint e which are in the interlocking relationship is represented by the parent node; and the link B and the link F respectively rotated by the joint b and the joint e are each represented by the child node. Further, the weighting representing the interlocking relationship between the joint b and the joint e is added to each of the respective edges corresponding to the joint b and the joint e. Specifically, the weighting of the constant Kₑ may be added to the edge corresponding to the joint b, and the weighting of the constant K_{b} may be added to the edge corresponding to the joint e.

According to this, the data generation apparatus 10 is able to generate: the first graph representing the linkage of the links of the link mechanism according to the first specific example; and the second graph representing the interlocking relationship between the joint b and the joint f.

### Second Specific Example

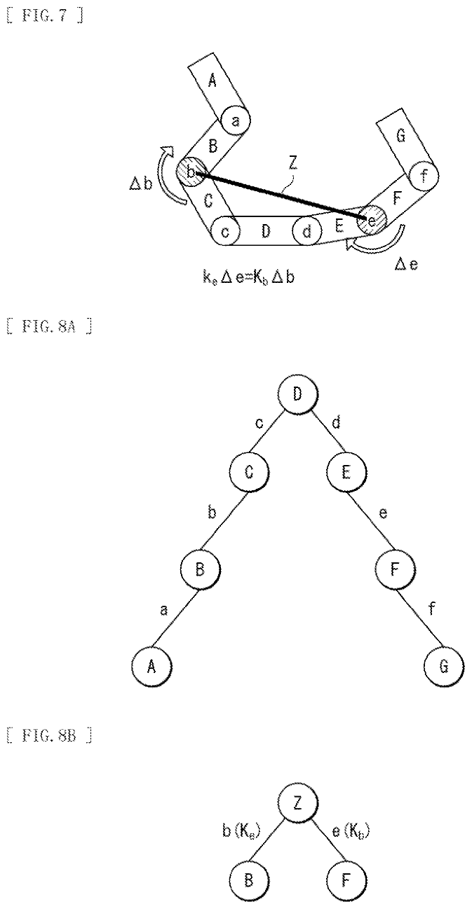

Next, referring to FIGS. 7 to 8B, a second specific example will be described. FIG. 7 is a schematic view of a structure of a link mechanism according to the second specific example. FIG. 8A is a graph diagram illustrating an example of the first graph generated by the data generation apparatus 10 on the basis of the link mechanism according to the second specific example. FIG. 8B is a graph diagram illustrating an example of the second graph generated by the data generation apparatus 10 on the basis of the link mechanism according to the second specific example.

As illustrated in FIG. 7, the link mechanism according to the second specific example includes: a link A, a link B, a link C, a link D, a link E, a link F, and a link G; and a joint a, a joint b, a joint c, a joint d, a joint e, and a joint f. Specifically, the joint c and the joint d are each linked to corresponding one of both ends of the link D. The joint c joins the link D and the link C to each other; the joint b provided on the other end, which is opposite to the joint c, of the link C joins the link C and the link B to each other; and the joint a provided on the other end, which is opposite to the joint b, of the link B joins the link B and the link A to each other. The joint d joins the link D and the link E to each other; the joint e provided on the other end, which is opposite to the joint d, of the link E joins the link E and the link F to each other; and the joint f provided on the other end, which is opposite to the joint e, of the link F joins the link F and the link G to each other.

In the link mechanism according to the second specific example, the joint e is the driving joint and the joint b is the driven joint that interlocks with the joint e. Specifically, there is the interlocking relationship between the joint e and the joint b that: when the joint e rotates by an angle Δe, the joint b rotates by an angle Δb. Using constants, the interlocking relationship between the joint e and the joint b is represented by Kₑ·Δe=K_{b}·Δb.

The graph in FIG. 8A represents the first graph generated for the link mechanism according to such a second specific example. Specifically, the first graph is a graph in which each of the links of the link mechanism related to the second specific example is represented by a node and each of the joints of the link mechanism related to the second specific example is represented by an edge. For example, the first graph may be a graph in which: the link C and the link E are joined to the link D serving as the parent node via the joint c and the joint e, respectively; the link B is joined to the link C via the joint b; the link A is joined to the link B via the joint a; the link F is joined to the link E via the joint f; and the link G is joined to the link F via the joint g.

Further, the graph in FIG. 8B represents the second graph generated for the link mechanism according to the second specific example. Specifically, the second graph is a graph in which: the virtual link that joins the joints which are in the interlocking relationship is represented by the parent node; and the links rotated by the respective joints which are in the interlocking relationship are each represented by the child node. For example, the second graph may be a graph in which: the virtual link Z that joins the joint b and the joint e which are in the interlocking relationship is represented by the parent node; and the link B and the link F respectively rotated by the joint b and the joint e are each represented by the child node. Further, the weighting representing the interlocking relationship between the joint b and the joint e is added to each of the respective edges corresponding to the joint b and the joint e. Specifically, the weighting of the constant Kₑ described above may be added to the edge corresponding to the joint b, and the weighting of the constant K_{b} described above may be added to the edge corresponding to the joint f.

According to this, the data generation apparatus 10 is able to generate: the first graph representing the linkage of the links of the link mechanism according to the second specific example; and the second graph representing the interlocking relationship between the joint b and the joint e.

### Third Specific Example

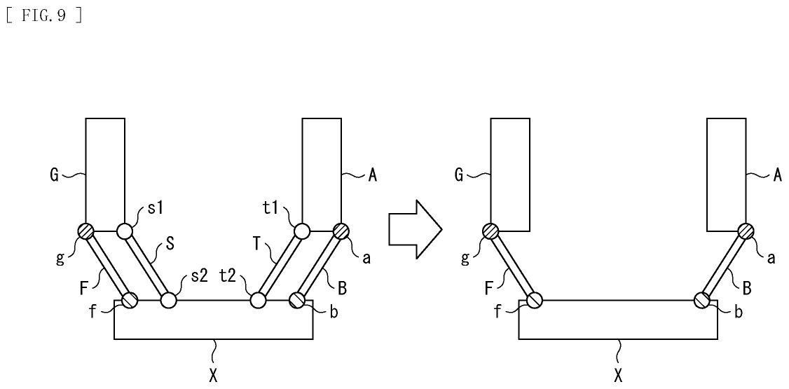

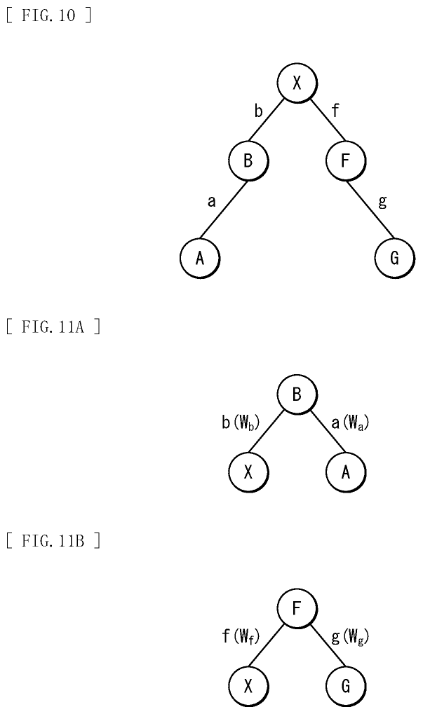

Next, referring to FIGS. 9 to 11B, a third specific example will be described. FIG. 9 is a schematic view of a structure of a link mechanism according to the third specific example. FIG. 10 is a graph diagram illustrating an example of the first graph generated by the data generation apparatus 10 on the basis of the link mechanism according to the third specific example. FIGS. 11A and 11B are each a graph diagram illustrating an example of the second graph generated by the data generation apparatus 10 on the basis of the link mechanism according to the third specific example.

As illustrated in FIG. 9, the link mechanism according to the third specific example includes: a link X, a link B, a link T, a link A, a link F, a link S, and a link G; and a joint b, a joint a, a joint t2, a joint t1, a joint f, a joint g, a joint s2, and a joint s1. The link mechanism according to the third specific example may be used, for example, for a two-finger hand of a mobile manipulator.

On one end of the link X, a parallel link mechanism is provided which includes the link X, the link B, the link T, and the link A. Specifically, the link X is provided with the joint b and the joint t2, and the link A is provided with the joint a and the joint t1, to form a closed-link structure in such a manner that the link B and the link T are parallel to each other and the link X and the link A are parallel to each other.

Further, on the other end of the link X, a parallel link mechanism is provided which includes the link X, the link F, the link S, and the link G. Specifically, the link X is provided with the joint f and the joint s2, and the link G is provided with the joint g and the joint s1, to form a closed-link structure in such a manner that the link F and the link S are parallel to each other and the link X and the link A are parallel to each other.

In the link mechanism according to the third specific example, the joint b is the driving joint, and the joint a, the joint t1, and the joint t2 are each the driven joint that interlocks with the joint b, owing to the parallel link mechanism. Further, the joint f is the driving joint, and the joint g, the joint s1, and the joint s2 are each the driven joint that interlocks with the joint f, owing to the parallel link mechanism. It is to be noted that, in the link mechanism according to the third specific example, the rotation of the joint b serving as the driving joint and the rotation of the joint f serving as the driving joint each cause the rotation of the other driven joints to be uniquely determined. Thus, the link mechanism according to the third specific example is not the underactuated system.

FIG. 10 represents the first graph generated for the link mechanism according to such a third specific example. Specifically, the link mechanism according to the third specific example includes the parallel link mechanism which has the closed-link structure. Accordingly, the first graph generator 110 converts the closed-link structure included in the parallel link mechanism into the open-link structure by removing the link T and the link S that are not linked to the driving joint, thereby generating a mechanism model as illustrated on the right-hand side of FIG. 9. Thereafter, the first graph generator 110 generates the first graph indicating a structure of the link mechanism on the basis of the generated mechanism model. For example, the first graph may be a graph in which: the link B and the link F are joined to the link X serving as the parent node via the joint b and the joint f, respectively; the link A is joined to the link B via the joint a; and the link G is joined to the link F via the joint f.

Further, the respective graphs in FIGS. 11A and 11B each represent the second graph generated for the link mechanism according to the third specific example. The link mechanism according to the third specific example has two sets of joints, and each of the two sets has the joints which are in the interlocking relationship. Thus, two second graphs are generated corresponding to the respective sets of joints which are in the interlocking relationship.

For example, as illustrated in FIG. 11A, the second graph indicating the interlocking relationship between the joint b and the joint a may be a graph in which: the link B that is the real link which joins the joint b and the joint a to each other is represented by the parent node; and the link X and the link A respectively rotated by the joint b and the joint a are each represented by the child node. Further, the weighting representing the interlocking relationship between the joint b and the joint a may be added to each of the respective edges corresponding to the joint b and the joint a. For example, weighting W_{b} and weighting Wₐ representing the interlocking relationship between the joint b and the joint a may be respectively added to the respective edges corresponding to the joint b and the joint a.

Further, as illustrated in FIG. 11B, the second graph indicating the interlocking relationship between the joint f and the joint g may be a graph in which: the link F that is the real link which joins the joint f and the joint g to each other is represented by the parent node; and the link X and the link G respectively rotated by the joint f and the joint g are each represented by the child node. Further, the weighting representing the interlocking relationship between the joint f and the joint g may be added to each of the respective edges corresponding to the joint f and the joint g. For example, weighting W_{f} and weighting W_{g} representing the interlocking relationship between the joint f and the joint g may be respectively added to the respective edges corresponding to the joint f and the joint g.

According to this, the data generation apparatus 10 is able to represent the closed-link structure of the link mechanism according to the third specific example by a plurality of acyclic graphs. Specifically, the data generation apparatus 10 is able to generate: the first graph representing the linkage of the links of the link mechanism according to the third specific example; and the second graph representing the interlocking relationship of the joints attributed to the closed-link structure by weighting. Thus, the data generation apparatus 10 is able to express the information related to the link mechanism having the closed-link structure in the acyclic graph that is easy to handle.

### Fourth Specific Example

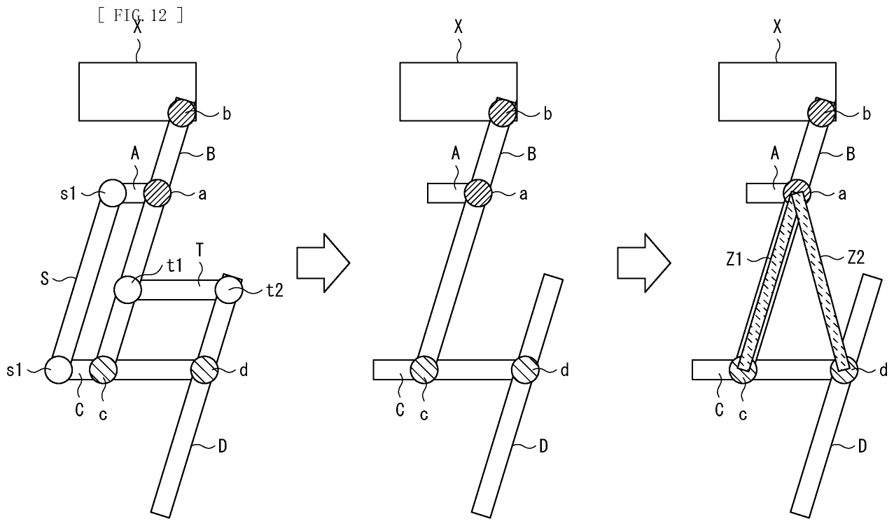

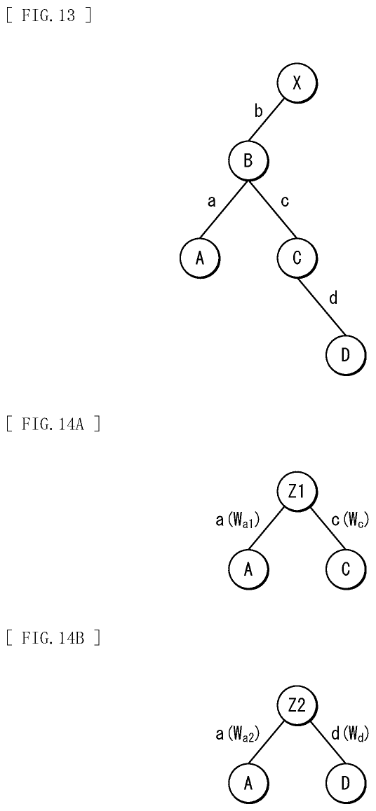

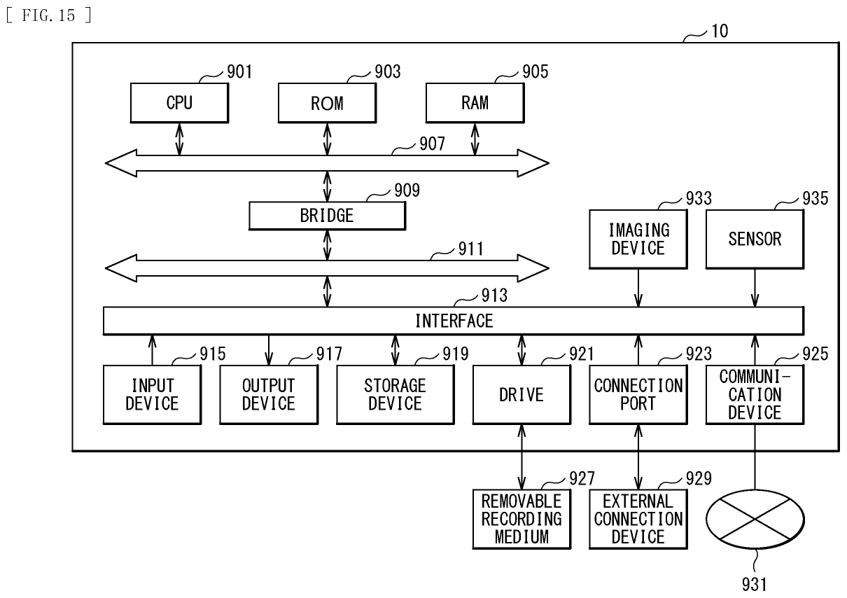

Next, referring to FIGS. 12 to 14B, a fourth specific example will be described. FIG. 12 is a schematic view of a structure of a link mechanism according to the fourth specific example. FIG. 13 is a graph diagram illustrating an example of the first graph generated by the data generation apparatus 10 on the basis of the link mechanism according to the fourth specific example. FIGS. 14A and 14B are each a graph diagram illustrating an example of the second graph generated by the data generation apparatus 10 on the basis of the link mechanism according to the fourth specific example.

As illustrated in on the left-hand side of FIG. 12, the link mechanism according to the fourth specific example includes: a link X, a link B, a link A, a link S, a link C, a link T, and a link D; and a joint b, a joint a, a joint s2, a joint s1, a joint c, a joint d, a joint t2, and a joint t1. The link mechanism according to the fourth specific example may be used, for example, for legs of a four-legged robotic device.

The link B is joined to the link X via the joint b. The link B forms a parallel link mechanism with the link A, the link S, and the link C. Specifically, the link B is provided with the joint a and the joint c, and the link S is provided with the joint s1 and the joint s2, to form a closed-link structure in such a manner that the link B and the link S are parallel to each other and the link A and the link C are parallel to each other.

Further, the link B forms a parallel link mechanism with the link T, the link D, and the link C. Specifically, the link B is provided with the joint t1 and the joint c, and the link D is provided with the joint t2 and the joint d, to form a closed-link structure in such a manner that the link B and the link D are parallel to each other and the link T and the link C are parallel to each other.

In the link mechanism according to the fourth specific example, the joint b and the joint a are each the driving joint, and the joint s1, the joint s2, the joint c, the joint t1, the joint t2, and the joint d are each the driven joint that interlocks with the joint a, owing to the two parallel link mechanisms. It is to be noted that, in the link mechanism according to the fourth specific example, the rotation of the joint a serving as the driving joint causes the rotation of the other driven joints to be uniquely determined. Thus, the link mechanism according to the fourth specific example is not the underactuated system.

FIG. 12 represents the first graph generated for the link mechanism according to such a fourth specific example. Specifically, the link mechanism according to the fourth specific example includes the parallel link mechanism which has the closed-link structure. Accordingly, the first graph generator 110 converts the closed-link structure included in the parallel link mechanism into the open-link structure by removing the link T and the link S that are not linked to the driving joint, thereby generating a mechanism model as illustrated on the center of FIG. 12. Thereafter, the first graph generator 110 generates the first graph indicating a structure of the link mechanism on the basis of the generated mechanism model. For example, the first graph may be a graph in which: the link B is joined to the link X serving as the parent node via the joint b; the link A and the link C are joined to the link B via the joint a and the joint c, respectively; and the link D is joined to the link C via the joint d.

Further, the respective graphs in FIGS. 14A and 14B each represent the second graph generated for the link mechanism according to the fourth specific example. In the link mechanism according to the fourth specific example, the joint c and the joint d, each serving as the driven joint, rotate in association with rotation of the joint a serving as the driving joint. Accordingly, the link mechanism according to the fourth specific example has two sets of joints, and each of the two sets has the joints which are in the interlocking relationship. Thus, two second graphs are generated corresponding to the respective sets of joints which are in the interlocking relationship. The second graph is a graph in which, as illustrated on the right-hand side of FIG. 12: the virtual link that joins the joints which are in the interlocking relationship is represented by the parent node; and the links rotated by the respective joints which are in the interlocking relationship are each represented by the child node.

For example, as illustrated in FIG. 14A, the second graph indicating the interlocking relationship between the joint a and the joint c may be a graph in which: a virtual link Z1 that joins the joint a and the joint c to each other is represented by the parent node; and the link A and the link C respectively rotated by the joint a and the joint c are each represented by the child node. Further, the weighting representing the interlocking relationship between the joint a and the joint c may be added to each of the respective edges corresponding to the joint a and the joint c. For example, weighting Wₐ₁ and weighting W_{c} representing the interlocking relationship between the joint a and the joint c may be respectively added to the respective edges corresponding to the joint a and the joint c.

Further, as illustrated in 14B, the second graph indicating the interlocking relationship between the joint a and the joint d may be a graph in which: a virtual link Z2 that joins the joint a and the joint d to each other is represented by the parent node; and the link A and the link D respectively rotated by the joint a and the joint d are each represented by the child node. Further, the weighting representing the interlocking relationship between the joint a and the joint d may be added to each of the respective edges corresponding to the joint a and the joint d. For example, weighting Wₐ₂ and weighting W_{d} representing the interlocking relationship between the joint a and the joint d may be respectively added to the respective edges corresponding to the joint a and the joint d.

According to this, the data generation apparatus 10 is able to represent the closed-link structure of the link mechanism according to the fourth specific example by a plurality of acyclic graphs. Specifically, the data generation apparatus 10 is able to: represent the linkage of the links of the link mechanism according to the fourth specific example by the first graph; and represent the interlocking relationship of the joints attributed to the closed-link structure by the weighted second graph. Thus, the data generation apparatus 10 is able to express the information related to the link mechanism having the closed-link structure in the acyclic graph that is easy to handle.

### 5. HARDWARE CONFIGURATION EXAMPLE

In addition, with reference to FIG. 15, a hardware configuration of the data generation apparatus 10 according to the present embodiment will be described. FIG. 15 is a block diagram illustrating the hardware configuration example of the data generation apparatus 10 according to the present embodiment. Functions of the data generation apparatus 10 according to the present embodiment may be implemented in conjunction with software and hardware to be described below.

As illustrated in FIG. 15, the data generation apparatus 10 includes a CPU (Central Processing Unit) 901, a ROM (Read Only Memory) 903, and a RAM (Random Access Memory) 905.

The data generation apparatus 10 may further include a host bus 907, a bridge 909, an external bus 911, an interface 913, an input device 915, an output device 917, a storage device 919, a drive 921, a connection port 923, or a communication device 925. Further, the data generation apparatus 10 may include an imaging device 933 or a sensor 935 as necessary. In addition, the data generation apparatus 10 may include a processing circuit such as a DSP (Digital Signal Processor) or an ASIC (Application Specific Integrated Circuit) instead of the CPU 901 or together with the CPU 901.

The CPU 901 functions as an arithmetic processing unit or a control unit and controls the operation in the data generation apparatus 10 according to various programs recorded in the ROM 903, the RAM 905, the storage device 919, or a removable recording medium 927. The ROM 903 stores programs and arithmetic parameters used by the CPU 901. The RAM 905 temporarily stores programs to be used in execution of the CPU 901 and parameters and the like to be used during the execution.

The CPU 901, the ROM 903, and the RAM 905 are coupled to each other via the host bus 907 including an internal bus such as a CPU bus or the like. In addition, the host bus 907 is coupled to the external bus 911 such as a PCI (Peripheral Component Interconnect/Interface) bus via the bridge 909.

The input device 915 is a device operated by a user, such as a mouse, a keyboard, a touch panel, a button, a switch, or a lever. The input device 915 may be a microphone or the like that detects a voice of the user. The input device 915 may be a remote control device using, for example, infrared light or other radio waves, or may be an external connection device 929 compatible with the operation of the data generation apparatus 10. Further, the imaging device 933 to be described later is also able to function as an input device by imaging a gesture such as a motion of a user's hand or finger.

The input device 915 further includes an input control circuit that outputs an input signal generated on the basis of information inputted by the user to the CPU 901. The user inputs various kinds of data to the data generation apparatus 10 or instructs the data generation apparatus 10 to perform a processing operation by operating the input device 915.

The output device 917 is a device that is able to visually or aurally notify the user of information acquired or generated by the data generation apparatus 10. The output device 917 may be, for example: a display device such as an LCD (Liquid Crystal Display), a PDP (Plasma Display Panel), an OLED (Organic Light Emitting Diode) display, a hologram display, or a projector; an audio output device such as a speaker or headphones; or a printing device such as a printer. The output device 917 is able to output information obtained by the processing performed by the data generation apparatus 10 as video in the form of text or an image, or as audio in the form of audio or sound.

The storage device 919 is a device for storing data configured as an example of a storage of the data generation apparatus 10. The storage device 919 may include, for example, a magnetic storage device such as an HDD (Hard Disk Drive), a semiconductor storage device, an optical storage device, or a magneto-optical storage device. The storage device 919 is able to store programs to be executed by the CPU 901, various kinds of data, and various kinds of data obtained from the outside.

The drive 921 is a reading device or a writing device for the removable recording medium 927 such as a magnetic disk, an optical disc, a magneto-optical disk, or a semiconductor memory, and is built in or externally attached to the data generation apparatus 10. For example, the drive 921 is able to read information recorded on the attached removable recording medium 927, and to output the information to the RAM 905. Further, the drive 921 is able to write the record on the attached removable recording medium 927.

The connection port 923 is a port for causing the external connection device 929 to be directly coupled to the data generation apparatus 10. Examples of the connection port 923 may include a USB (Universal Serial Bus) port, an IEEE1394 port, an SCSI (Small Computer System Interface) port, and the like. Further, other examples of the connection port 923 may include an RS-232C port, an optical audio terminal, an HDMI (registered trademark) (High-Definition Multimedia Interface) port, and the like. By coupling the external connection device 929 to the connection port 923, it becomes possible to transmit and receive various kinds of data between the data generation apparatus 10 and the external connection device 929.

The communication device 925 is a communication interface including, for example, a communication device for establishing a connection to a communication network 931. The communication device 925 may be, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like.

The communication device 925 is able to transmit and receive signals and the like using a predetermined protocol such as TCP/IP on the Internet and with other communication devices, for example. Further, the communication network 931 connected to the communication device 925 is a network and the like, which is connected via wire or wirelessly. The communication network 931 may be, for example, an Internet communication network, a home-use LAN, an infrared communication network, a radio wave communication network, a satellite communication network, or the like.

The imaging device 933 is a device that images real space using various members including an image sensor such as a CCD (Charge Coupled Device) or a CMOS (Complementary Metal-Oxide-Semiconductor), a lens that controls image formation of a subject on the image sensor, and the like, and that generates a captured image. The imaging device 933 may image a still image or may image a video.

The sensor 935 is a sensor that acquires, for example, information related to a state of the data generation apparatus 10 itself, or information related to an ambient environment of the data generation apparatus 10. The sensor 935 may be, for example, a range sensor, an acceleration sensor, a gyro sensor, a geomagnetic sensor, a vibration sensor, an optical sensor, or an audio sensor. Further, the sensor 935 may also be a GNSS sensor that receives GNSS (Global Navigation Satellite System) signals and measures latitude, longitude, and altitude of the apparatus.

It is to be noted that, it is also possible to create a program for causing hardware such as the CPU 901, the ROM 903, or the RAM 905 built in a computer to exhibit substantially the same functions as the data generation apparatus 10 described above. Further, there may also be provided a computer-readable recording medium having the program recorded thereon.

For example, the functions of the first graph generator 110 and the second graph generator 120 may be executed by the CPU 901, for example. The functions of the acquisition section 131 may be executed, for example, by the input device 915, the imaging device 933, the sensor 935, the drive 921, the connection port 923, or the communication device 925. The functions of the output section 132 may be executed, for example, by the output device 917, the drive 921, the connection port 923, or the communication device 925.

### 6. APPENDIX

The technology according to the present disclosure has been described above. However, the technology according to the present disclosure is not limited to the foregoing embodiments, etc., and may be modified in a variety of ways. For example, the technology according to the present disclosure may be executed not only by the data generation apparatus 10 alone, but also by a system including a plurality of information processing apparatuses.

Further, not all of the configurations and operations described in the respective embodiments are indispensable as the configurations and operations of the present disclosure. For example, among the components in the respective embodiments, components not described in the independent claim indicating the most significant concepts of the present disclosure are to be understood as optional components.

Terms used throughout this specification and the appended claims should be construed as “non-limiting” terms. For example, a term “comprise” or “include” should be construed as “not being limited to those recited as included”. The term “have” should be construed as “not being limited to those recited as included”.

Terms used herein are used merely for convenience of description, and include those whose configuration and operation are not limited. For example, the terms “right”, “left”, “top” and “bottom” merely indicate the directions on the drawing to which is being referred. The terms “inner side” and “outer side” refer to a direction toward the center of the element of interest and a direction away from the center of the element of interest, respectively. The same applies to terms similar to these terms and terms having the similar meaning.

It is to be noted that the present technology may have the following configurations. According to the technology according to the present disclosure having the following configurations, it is possible to express a closed-link structure included in a link mechanism by a combination of a plurality of acyclic graphs. It becomes possible to easily handle the structure and movement of the link mechanism in more components and software bases. It is to be noted that the effects described herein are not necessarily limiting, and any of the effects described in the present disclosure may be provided.

(1)

A data generation apparatus including:

a first graph generator that generates a first graph representing a structure of a link mechanism; and

a second graph generator that generates a second graph representing an interlocking relationship between a driving joint and a driven joint, the driving joint and the driven joint being included in the link mechanism, the driven joint being driven in a manner that the driven joint interlocks with the driving joint.

(2)

The data generation apparatus according to (1), in which the first graph generator generates a mechanism model in which a closed-link structure of the link mechanism is converted into an open-link structure by removing a dependent link from the link mechanism, and generates the first graph on a basis of the mechanism model.

(3)

The data generation apparatus according to (2), in which the second graph generator generates the second graph representing the interlocking relationship between the driving joint and the driven joint, the driving joint and the driven joint being included in the mechanism model.

(4)

The data generation apparatus according to (3), in which the second graph generator generates, as the second graph, a graph in which: a virtual link that joins the driving joint and the driven joint to each other is represented by a parent node; and links that are linked to respective joints of the driving joint and the driven joint are each represented by a child node.

(5)

The data generation apparatus according to (4), in which a link to be served as the child node in the second graph is, among links that are linked to the driving joint or the driven joint, a link that does not contribute to joining between the driving joint and the driven joint in the mechanism model.

(6)

The data generation apparatus according to any one of (1) to (5), in which supplementary information indicating the interlocking relationship between the driving joint and the driven joint is added to the second graph.

(7)

The data generation apparatus according to (6), in which the supplementary information is represented by weighting of each link, or a polynomial.

(8)

The data generation apparatus according to any one of (1) to (7), in which the second graph is generated for each interlocking relationship between the driving joint and the driven joint included in the link mechanism.

(9)

The data generation apparatus according to any one of (1) to (8), in which the first graph and the second graph are each represented by a graph in which: a link is represented by a node; and a joint is represented by an edge.

(10)

The data generation apparatus according to (9,) in which the first graph and the second graph are each represented by an acyclic graph.

(11)

The data generation apparatus according to any one of (1) to (10), in which the link mechanism is not an underactuated system.

(12)

The data generation apparatus according to any one of (1) to (11), in which the link mechanism is a machine element included in a robotic device.

(13)

The data generation apparatus according to any one of (1) to (12), in which the first graph and the second graph are transmitted to an external component.

(14)

A data generation system including:

a first graph generator that generates a first graph representing a structure of a link mechanism; and

a second graph generator that generates a second graph representing an interlocking relationship between a driving joint and a driven joint, the driving joint and the driven joint being included in the link mechanism, the driven joint being driven in a manner that the driven joint interlocks with the driving joint.

This application claims the benefit of Japanese Priority Patent Application JP2019-142968 filed with the Japan Patent Office on Aug. 2, 2019, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A data generation apparatus comprising:
a first graph generator that generates a first graph representing a structure of a link mechanism; and
a second graph generator that generates a second graph representing an interlocking relationship between a driving joint and a driven joint, the driving joint and the driven joint being included in the link mechanism, the driven joint being driven in a manner that the driven joint interlocks with the driving joint.

2. The data generation apparatus according to claim 1, wherein the first graph generator generates a mechanism model in which a closed-link structure of the link mechanism is converted into an open-link structure by removing a dependent link from the link mechanism, and generates the first graph on a basis of the mechanism model.

3. The data generation apparatus according to claim 2, wherein the second graph generator generates the second graph representing the interlocking relationship between the driving joint and the driven joint, the driving joint and the driven joint being included in the mechanism model.

4. The data generation apparatus according to claim 3, wherein the second graph generator generates, as the second graph, a graph in which: a virtual link that joins the driving joint and the driven joint to each other is represented by a parent node; and links that are linked to respective joints of the driving joint and the driven joint are each represented by a child node.

5. The data generation apparatus according to claim 4, wherein a link to be served as the child node in the second graph is, among links that are linked to the driving joint or the driven joint, a link that does not contribute to joining between the driving joint and the driven joint in the mechanism model.

6. The data generation apparatus according to claim 1, wherein supplementary information indicating the interlocking relationship between the driving joint and the driven joint is added to the second graph.

7. The data generation apparatus according to claim 6, wherein the supplementary information is represented by weighting of each link, or a polynomial.

8. The data generation apparatus according to claim 1, wherein the second graph is generated for each interlocking relationship between the driving joint and the driven joint included in the link mechanism.

9. The data generation apparatus according to claim 1, wherein the first graph and the second graph are each represented by a graph in which: a link is represented by a node; and a joint is represented by an edge.

10. The data generation apparatus according to claim 9, wherein the first graph and the second graph are each represented by an acyclic graph.

11. The data generation apparatus according to claim 1, wherein the link mechanism is not an underactuated system.

12. The data generation apparatus according to claim 1, wherein the link mechanism is a machine element included in a robotic device.

13. The data generation apparatus according to claim 1, wherein the first graph and the second graph are transmitted to an external component.

14. A data generation system comprising:
a first graph generator that generates a first graph representing a structure of a link mechanism; and
a second graph generator that generates a second graph representing an interlocking relationship between a driving joint and a driven joint, the driving joint and the driven joint being included in the link mechanism, the driven joint being driven in a manner that the driven joint interlocks with the driving joint.
